(19) United States
(12) Patent Application Publication
(10) Pub. No.: US 2009/0291719 A1
(43) Pub. Date: Nov. 26, 2009

(54) Joint cover

(75) Inventor: Morten Rolighed Christensen, Lyngby (DK)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/154,606

(22) Filed: May 23, 2008

(51) Int. Cl. H04M 1/00

(52) U.S. Cl. 455/575.3

(57) ABSTRACT

An apparatus including a first housing section; a second housing section rotatably connected to the first housing section between a closed position and an open position; and an opening system. The opening system is connected between the first and second housing sections and configured to move the second housing section relative to the first housing section towards the open position. The opening system includes a flexible thin foil and a tension spring. The tension spring exerts a pulling force against the foil.

### BACKGROUND OF THE INVENTION

1. Field of the Invention

The invention relates to a junction between two pivotable members and, more particularly, to a flexible member which covers the junction.

2. Brief Description of Prior Developments

Folding or clamshell telephone handsets have traditionally had visible split lines in a hinge area between two housing sections. Some designs include a spring mounted in the hinge cylinder, and usually include a flexible printed circuit (FPC) or coax cable interconnection through the hinge cylinder.

### SUMMARY

The following summary is merely intended to be exemplary. The summary is not intended to limit the scope of the claimed invention.

In accordance with one aspect of the invention, an apparatus is provided including a first housing section; a second housing section rotatably connected to the first housing section between a closed position and an open position; and an opening system. The opening system is connected between the first and second housing sections and configured to move the second housing section relative to the first housing section towards the open position. The opening system includes a flexible thin foil and a tension spring. The tension spring exerts a pulling force against the foil.

In accordance with another aspect of the invention, an apparatus is provided comprising a first housing section, a second housing section, a flexible thin sheet member, and a connection of the sheet member to the first housing section. The second housing section is pivotably connected to the first housing section at a hinge section. The second housing section is pivotable relative to the first housing section between a closed position and an open position. The flexible thin sheet member extends between the first and second housing sections over an exterior of the hinge section. The sheet member is located at least partially along outside surfaces of the first and second housing sections. A first end of the sheet member is stationarily attached to the second housing section. The connection of the sheet member to the first housing section comprises a spring connected between the first housing section and an opposite second end of the sheet member. The spring exerts a pulling force on the second end of the sheet member in a predetermined direction on the first housing section.

In accordance with another aspect of the invention, a method is provided comprising rotatably connecting a first housing section with a second housing section at a hinge section; connecting a flexible thin foil member to the second housing section, wherein the thin foil member extends over an exterior of the hinge section and onto the first housing section; and connecting a spring between the foil member and the first housing section to bias the foil member in tension towards a predetermined direction on the first housing section.

In accordance with another aspect of the invention, a method is provided comprising rotating first and second housing sections relative to each other from a closed position towards an open position; and pulling on a foil member by a spring as the first and second housing sections are moved towards the open position. The foil member is located over an exterior side of a hinge section connecting the first and second housing sections to each other. The spring connects the foil member to the first housing section to pull the foil member in a predetermined direction on the first housing section as the first and second housing sections move towards the open position.

### BRIEF DESCRIPTION OF THE DRAWINGS

The foregoing aspects and other features of the invention are explained in the following description, taken in connection with the accompanying drawings, wherein:

FIG. 1 is a perspective view of an apparatus incorporating features of the invention in a closed configuration;

FIG. 2 is a perspective view of the apparatus shown in FIG. 1 is an open configuration;

FIG. 3 is a perspective view of the apparatus as in FIG. 2 from an opposite direction;

FIG. 4 is a perspective view of the opening system used in the apparatus shown in FIGS. 1-3;

FIG. 5 is a partial, and partially exploded, perspective view of some of the components of the apparatus shown in FIG. 2;

FIG. 6 is a top plan view of a portion of the opening system shown in FIG. 4 inside the first housing member of the apparatus shown in FIG. 5;

FIG. 7 is a side view of the apparatus shown in FIGS. 2-3 with an electrical conductor cable along the exterior of the hinge section;

FIG. 8 is a block diagram illustrating some steps which could be used to manufacture an apparatus comprising features of the invention;

FIG. 9 is a block diagram illustrating some steps of using an apparatus comprising features of the invention;

FIG. 10 is a front perspective view of an alternate embodiment of the invention showing the housing members in a closed position relative to each other;

FIG. 11 is a rear perspective view of the embodiment shown in FIG. 10; and

FIG. 12 is a perspective view of the embodiment shown in FIGS. 10-11 with the two housing members located in the open position.

### DETAILED DESCRIPTION OF THE EMBODIMENT

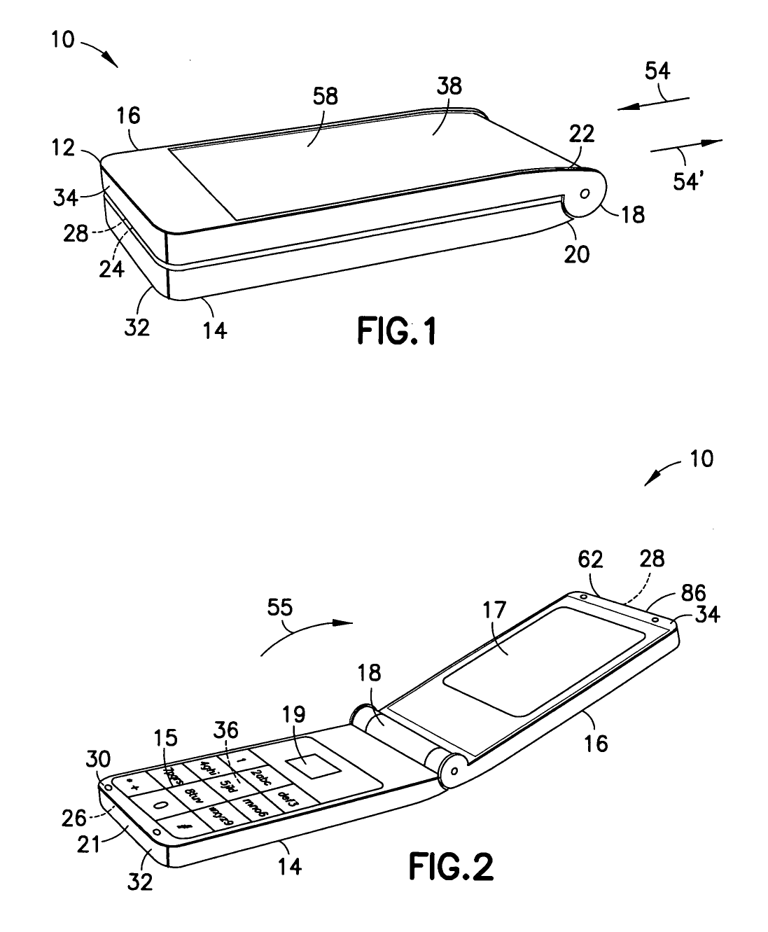

Referring to FIG. 1, there is shown a perspective view of an apparatus 10 incorporating features of the invention. Although the invention will be described with reference to the exemplary embodiment shown in the drawings, it should be understood that the invention can be embodied in many alternate forms of embodiments. In addition, any suitable size, shape or type of elements or materials could be used.

The apparatus, in this exemplary embodiment, is a portable electronic device and, more specifically, a hand-held mobile telephone handset. The handset has a flip-phone type of design. However, features of the invention could be used with any type of portable electronic device having housing members which are movable relative to each other, such as a gaming device, a PDA, etc.

The handset 10 generally comprises a housing 12 having a first housing member or section 14 and a second housing member or section 16. Referring also to FIGS. 2-3, the first and second housing members 14, 16 are pivotably connected to each other by a hinge section 18. In this embodiment, portions of the first and second housing members form portions of the hinge section. The first and second housing members 14, 16 are pivotable between a closed position as shown in FIG. 1 and an open position as shown in FIGS. 2-3. The hinge section 18 connects the top ends 20, 22 of the housing members to each other.

In this embodiment the first housing member 14 generally comprises electronic circuitry 36 including a transceiver, a battery, an alphanumeric keypad 15, control keys 19 and a microphone 21. The second housing member 16 generally comprises a display 17 and a sound transducer or speaker 86. When the first and second housing members are in their closed position as shown in FIG. 1, the display 17 is protectively covered by the first housing member 14 and the keypad 15 is protectively covered by the second housing member 16.

In order to use most features of the handset, the second housing member 16 must be moved to its open position. This uncovers the display and the keypad. In this embodiment the telephone has an opening system or open assist system which is adapted to bias the housing members 14, 16 towards the open position.

The telephone 10 also comprises a latch system 24 for latching the first and second housing members at the closed position. In this embodiment the latch system comprises a permanent magnet 26 in the first housing member 14 and a suitable magnetically latchable ferromagnetic member 28 in the second housing member 16. The magnet 26 and latchable member 28 are located proximate top and bottom sides 30, 62, respectively, of the bottom ends 32, 34 of the housing members 14, 16. The magnet 26 and the latchable member 28 function as a latch to retain the second housing member 16 against the top side 30 of the first housing member 14 at the closed position. In an alternate embodiment, the latching system to retain the first and second housings in their closed position could comprise any suitable type of latching system including, for example, a resilient latching snap or other mechanical design such as a detent system for example. Thus, the type of latch is not limited to merely a magnetic latch.

In order to overcome the latching system 24 and move the second housing member 16 from the closed position, the handset 10 could comprise a latch release system (not shown), or the latching system 24 could be overcome merely by a user's finger or fingernail initially inserted between the top and bottom sides 30, 62. Once the latching system 24 is initially disengaged, the opening system can assist in causing the second housing member 16 to move towards the open position; with the two housing members 14, 16 pivoting relative to each other at the hinge section 18.

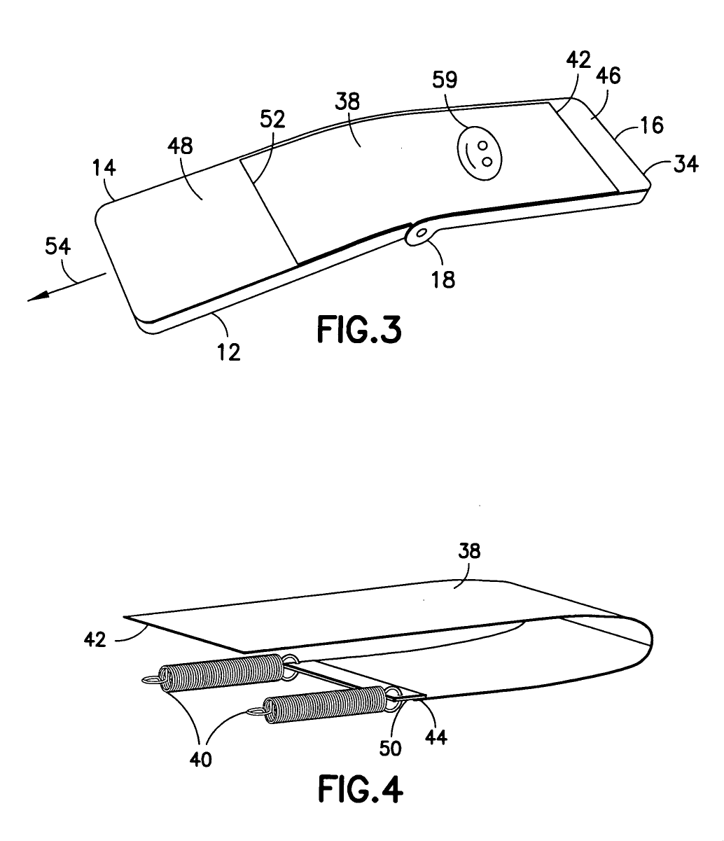

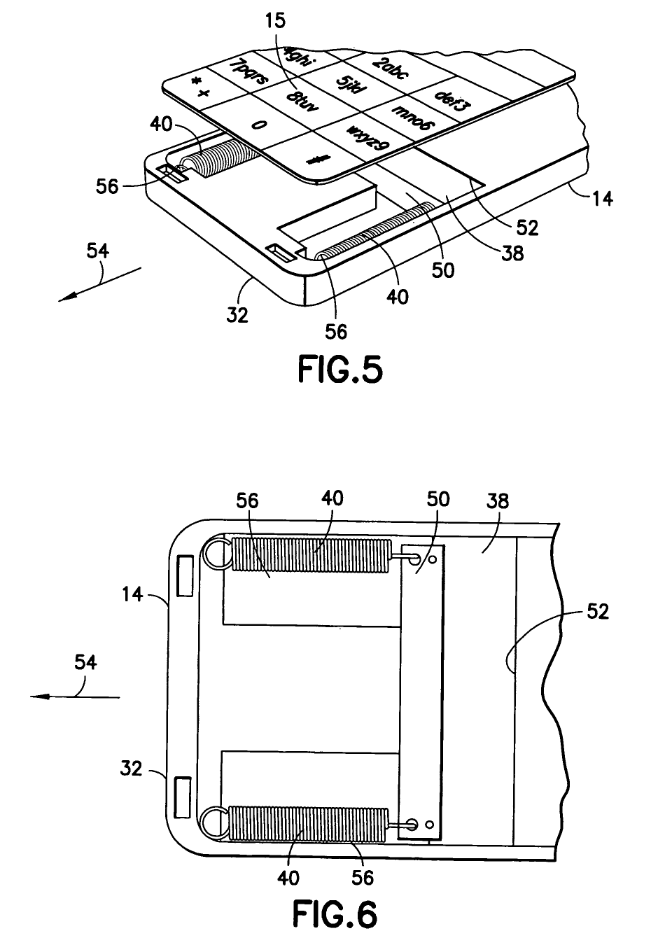

Referring also to FIGS. 4-6, the opening system comprises a flexible member 38 and springs 40. The flexible member 38 comprises a foil or sheet member. In one example embodiment the foil 38 is comprised of metal, such as steel. However, in alternate embodiments any suitable material or combination of materials could be used including a superelastic shape memory alloy, such as NITINOL for example. The foil 38 is flexible and very thin, such as about 0.3 mm for example.

A first end 42 of the foil 38 can be fixedly, stationarily attached to the second housing member 16 proximate the end 34. However, in an alternate embodiment the first end 42 might be slidably connected to the second housing member 16. In one type of example embodiment the connection of the foil 38 to the housing 12 is removable, but could be permanent. An opposite second end 44 of the foil 38 is connected to one end of the springs 40.

The foil 38, in this embodiment, has a width which is about the same width as the widths of the first and second housing member; merely slightly smaller. In this embodiment where the hinge section is located at the short dimension of the first and second housing members, the foil 38 also has a longitudinal length which is greater than a longitudinal length of the first housing member and greater than a longitudinal length of the second housing member.

As seen best in FIG. 3, the foil 38 in the first embodiment is located against the exterior side 46 of the second housing member 16. The foil 38 extends over the exterior of the hinge section 18 and onto the exterior side 48 of the first housing member 14. Lateral side edges of the foil member 38 might be located in rail channels of the first and/or second housing members at their exterior sides 46, 48. Referring also to FIGS. 4-6, the end 44 of the foil 38 extends through a slot 52 in the side 48 of the first housing member 14 and into an interior of the first housing member 14.

The springs 40 provide a connection between the end 44 of the foil 38 and the first housing member 14. The springs 40, in this embodiment, are coil or helix tension springs. Two springs are shown in this embodiment. However, in alternate embodiments, more or less than two springs could be provided. In addition, a suitable connection of the end 44 to the first housing member 14 could be provided to use a compression spring rather than a tension spring. In alternate embodiments, a spring other than a coil spring could also be used. In the embodiment shown, a strengthener or re-enforcer 50 is provided on the end 44 to prevent the end 44 from tearing at the connections of the ends of the springs 40 to the end 44. First ends of the springs 40 are connected to the end 44 of the foil 38 by the strengthener 50. Opposite second ends of the springs 40 are fixedly connected directly on the first housing member 14. The first housing member 14 includes one or more cavities 56 to house the springs 40 in the first housing member spaced from the hinge section 18. Thus, the springs can be housed entirely in the cavities. However, in an alternate embodiment the spring might be outside the cavities; wholly or partially. The springs 40 exert a pulling force in direction 54 on the end 44 of the foil 38. Each spring 40 comprises an extension and contraction axis parallel to an elongate longitudinal axis of the first housing member.

When the handset 10 is in the closed position as shown in FIG. 1, the force of the springs do not provide any significant opening bias of the first and second housing member relative to each other. This is because the force 54 is cancelled out by the equal and opposite force 54′ provided in view of the folded nature of the handset. However, after the housing members 14, 16 are initially opened, the tension or pulling force exerted by the springs 40 on the foil 38 causes the foil 38 to be partially pulled into the slot 52. The springs 40 shorten while they retract. The end 34 is pulled towards the open position as shown by arrow 55 with the two housing members 14, 16 rotating at the hinge section 18. Thus, the springs and the foil assist in moving the second housing member towards the open position. When the user moves the second housing section 16 back to its closed position, the portion of the foil 38 which was pulled into the slot 52 is once again pulled outward from the slot 52 with the springs 40 expanding again.

The invention provides an alternative open mechanism, interconnection and design than conventional designs used in hinged devices. In this invention the metal foil can be substituted with an elastic band, such as a rubber band, or a spring type watch link for example. The non-elastic but bendable thin steel foil can be substituted with an elastic foil or a metal bracelet (similar to an arm watch). This will give the same function, but can save space while the spring load is then integrated in the “foil”. This could save space in the first housing member compared to the helix spring embodiment described above. A lot of decoration possibilities on foil are also possible. For example, the exterior side 58 of the foil 38 could be decorated, such as by being etched or engraved to form a decoration 59. In the embodiment shown the foil is removably connected to the first and second housing members such that an end user can replace the foil with a second different foil having a different decoration on the exterior of the second foil. In an alternate embodiment the foil might not be designed to be removable by the end user.

The invention can provide a cleaner looking profile than conventional designs. This is because, in the embodiment shown, the foil covers the exterior of the hinge section and a majority of the exterior side of the second housing member (as well as a significant portion of the exterior side of the first housing section, such as about 30 percent for example). The foil 38 could be used for electromagnetic shielding purposes at the hinge section 18 and elsewhere. The invention can allow for use of a thinner or smaller hinge section 18 than conventional designs because the opening spring does not need to be located inside the hinge cylinder and the electrical cable connecting components in the two housing members to each other does not need to be inside the hinge cylinder.

The invention does not need to be used as part of an open assist system or device. Instead, the invention could merely be used to take up the slack in the flexible member 38 (which would otherwise be generated when the handset is opened). An entirely separate open assist system could be provided. Alternatively, no open assist system might be provided. As another alternative, the open assist system of the invention could be used in combination with another open assist system, such as a spring in the hinge for example.

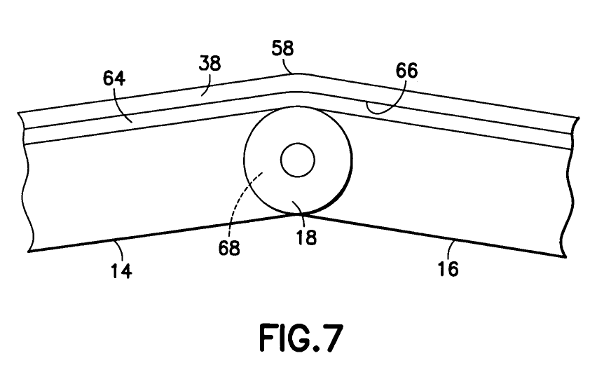

Referring also to FIG. 7, in this embodiment a flexible, flat printed circuit (FPC) cable 64 is located outside the hinge section 18. The FPC cable 64 electrically connects electrical components in the first and second members 14, 16 to each other. The FPC cable 64 is located against the interior facing side 66 of the foil 38. Because the FPC cable is not located inside the hinge section 18, this allows the hinge section 18 to be smaller than conventional hinge sections. However, in an alternate embodiment the FPC cable or a coaxial cable could be provided extending through the hinge section 18. In the embodiment shown, however, the foil 38 can function as an electromagnetic shield to shield the cable 64 (and perhaps shielding other components in the housing members 14, 16), as well providing a flexible mechanical link or stringer for the open assist system.

In one type of embodiment the flexible member 38 could comprise a FPC integrally formed thereon. In another embodiment the flexible member 38 might form part of an antenna for the transceiver of the handset. Thus, the flexible member 38 can be used to perform multiple functions including, for example, the flexible mechanical link for the open assist system, a shield for electrical component(s), part of a conductor cable or flexible printed circuit, and/or part of one or more antennas. At least a portion of one or more springs of the open assist system could be formed by part of the flexible member 38. However, in one type of embodiment, the flexible member 38 does not provide any significant spring forces for opening the housing members relative to each other when compared to the springs 40. However, in an alternate embodiment, the flexible member 38 might be used to function as a spring for opening the housing members relative to each other; used in combination with the spring force of the springs 40. Thus, the springs 40 could be provided as smaller springs in view of the spring force provided internally by the flexible member 38.

In the embodiment shown, only one flexible member 38 is provided (which can also function as a decorative surface for the handset). However, in an alternate embodiment more than one flexible member could be provided, and/or the flexible member could be comprised of an assembly of multiple members. However, the single flexible member embodiment described above provides a sleek styling component and would be less expensive to manufacture.

In one type of embodiment the handset 10 is provided with a damper 68 in the hinge section 18. The damper is adapted to dampen (an otherwise potentially too fast) swinging open of the second housing member 16 relative to the first housing member 14. However, in an alternate embodiment a damper or system for slowing down the speed of relative movement of the two housing members 14, 16 relative to each other might not be provided.

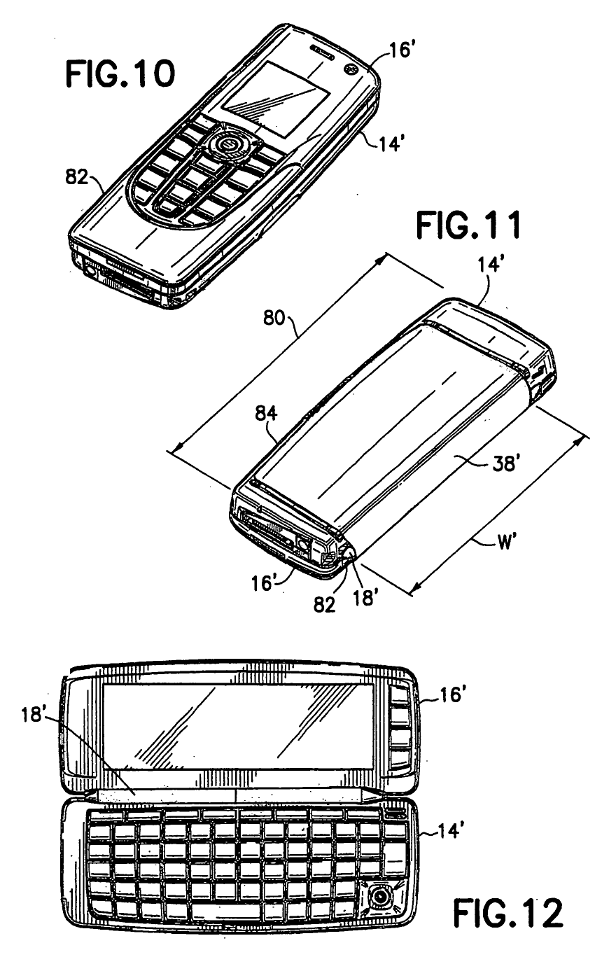

In an alternate embodiment, such as when the hinge section is at a long dimension of the first and second housing members 14′, 16′ as shown in FIGS. 10-12, the flexible sheet member (or foil) 38′ can have a longitudinal width WI which is about the same as the longest dimension 80 of the first and second members, and a length extending over the hinge section 18′. In this embodiment the sheet member 38′ does not extend over the exterior side of the second housing member 16′. Instead, the sheet member 38′ is attached at the lateral side 82 of the second housing member 16′. The opposite end of the sheet member extends through a slot 84 at the exterior side of the first housing member 14′ and is biased by a spring in an inward direction into the slot. Thus, as the second housing member 16′ is moved to the open position, the member 38′ is kept taunt; pulled into the slot 84. In this embodiment the sheet member 38′ extends over a majority of the length and width of the exterior side of the first housing member 14′. However, in an alternate embodiment, the sheet member 38′ might not extend over a majority of the length and/or width of the exterior side of the first housing member 14′.

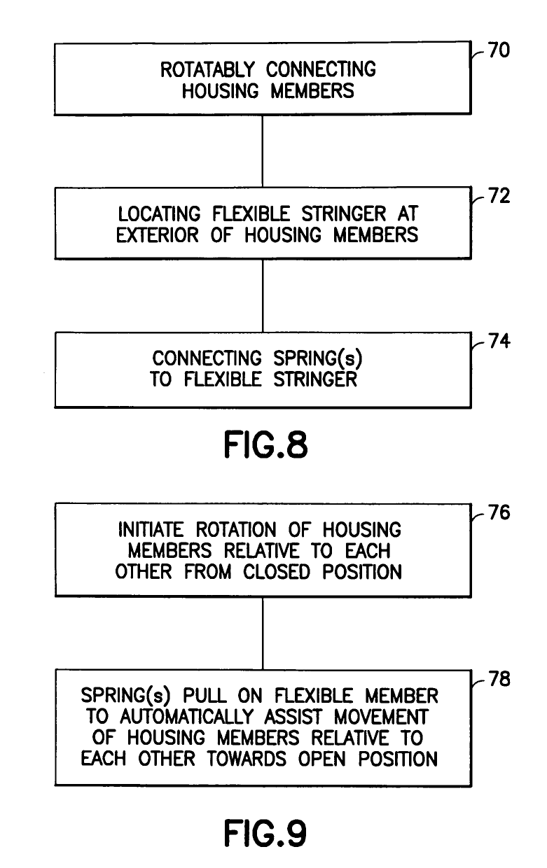

Referring also to FIG. 8, one method of manufacturing an apparatus comprising features of the invention could include rotatably connecting a first housing member with a second housing member at a hinge section as indicated by block 70; locating a flexible stringer at exterior sides of the housing members, as indicated by block 72, and connecting the stringer (flexible thin foil member) to the second housing member, wherein the thin foil member extends over an exterior of the hinge section and onto the first housing member; and connecting a spring between the stringer and the first housing member as indicated by block 74 to bias the stringer in tension towards a predetermined direction on the first housing member.

Referring also to FIG. 9, one method of using an apparatus comprising the invention can include rotating first and second housing sections relative to each other from a closed position towards an open position as indicated by block 76; and as indicated by block 78 pulling on a flexible member by a spring as the first and second housing sections are moved towards the open position, wherein the flexible member is located over an exterior side of a hinge section connecting the first and second housing sections to each other, and wherein the spring connects the flexible member to the first housing section to pull the flexible member in a predetermined direction on the first housing section as the first and second housing sections move towards the open position.

In accordance with one aspect of the invention, an apparatus is provided comprising a first housing section 14; a second housing section 16 rotatably connected to the first housing section between a closed position (see FIG. 1) and an open position (see FIG. 2); and an opening system. The opening system is connected between the first and second housing sections and is configured to move the second housing section relative to the first housing section towards the open position. The opening system includes a flexible thin foil 38 and a tension spring 40. The tension spring exerts a pulling force against the foil.

In accordance with another aspect of the invention, an apparatus is provided comprising a first housing section 14, a second housing section 16, a flexible thin sheet member 38, and a connection of the sheet member to the first housing section. The second housing section is pivotably connected to the first housing section at a hinge section 18. The second housing section is pivotable relative to the first housing section between a closed position (see FIG. 1) and an open position (see FIG. 2). The flexible thin sheet member extends between the first and second housing sections over an exterior of the hinge section. The sheet member is located at least partially along outside surfaces 46, 48 of the first and second housing sections. A first end 42 of the sheet member is stationarily attached to the second housing section. The connection of the sheet member to the first housing section comprises a spring 40 connected between the first housing section and an opposite second end 44 of the sheet member. The spring exerts a pulling force on the second end of the sheet member in a predetermined direction 54 on the first housing section.

In accordance with another aspect of the invention, a method is provided comprising rotatably connecting a first housing section 14 with a second housing section 16 at a hinge section 18; connecting a flexible thin foil member 38 to the second housing section, wherein the thin foil member extends over an exterior of the hinge section and onto the first housing section; and connecting a spring 40 between the foil member and the first housing section to bias the foil member in tension towards a predetermined direction 54 on the first housing section.

In accordance with another aspect of the invention, a method is provided comprising rotating first and second housing sections 14, 16 relative to each other from a closed position towards an open position; and pulling on a foil member 38 by a spring 40 as the first and second housing sections are moved towards the open position. The foil member is located over an exterior side of a hinge section 18 connecting the first and second housing sections to each other. The spring connects the foil member to the first housing section to pull the foil member in a predetermined direction 54 on the first housing section as the first and second housing sections move towards the open position.

In one embodiment of the invention, the invention can provide the advantage of a connection between two housing sections which overcome problems of complex design in the hinge area between the housing sections. In one embodiment of the invention, the invention can provide the advantage of a decorative member which traverses over a hinge area in a hand-held folding device. In one embodiment of the invention, the invention can provide the advantage of an open assist system which can assist in opening a hand-held folding device towards an open position, but which does not need to be located inside the hinge cylinder which connects the housing sections of the folding device to each other.

In accordance with another aspect of the invention, an apparatus is provided comprising a first housing section 14; a second housing section 16 rotatably connected to the first housing section between a closed position (see FIG. 1) and an open position (see FIG. 2); and means for assisting movement of the first and second housing sections towards the open position. The means for assisting movement of the first and second housing sections is configured to move the second housing section relative to the first housing section towards the open position. The means for assisting movement includes a non-elastic flexible member 38 and a spring 40. The spring exerts a biasing force against the non-elastic flexible member.

In accordance with another aspect of the invention, an apparatus is provided comprising a first housing section 14; a second housing section 16 rotatably connected to the first housing section by a hinge section 18 between a closed position (see FIG. 1) and an open position (see FIG. 2); a flexible member extending over an exterior of the hinge section; and means for pulling a portion of the flexible member inside the first housing section from outside the first housing section when the first and second housing sections move towards the open position. The means for pulling includes a spring 40. The spring exerts a biasing force against the non-elastic flexible member.

It should be understood that the foregoing description is only illustrative of the invention. Various alternatives and modifications can be devised by those skilled in the art without departing from the invention. For example, features recited in the various dependent claims could be combined with each other in any suitable combination(s). Accordingly, the invention is intended to embrace all such alternatives, modifications and variances which fall within the scope of the appended claims.

What is claimed is:

1. An apparatus comprising:
a first housing section;
a second housing section rotatably connected to the first housing section between a closed position and an open position; and
an opening system connected between the first and second housing sections and configured to move the second housing section relative to the first housing section towards the open position, wherein the opening system comprises a flexible thin foil and a tension spring, and wherein the tension spring exerts a pulling force on the foil.

2. An apparatus as in claim 1 wherein a first end of the foil is connected to the second housing section, wherein a second end of the foil is connected to a first end of the tension spring, and wherein a second end of the tension spring is connected to the first housing section.

3. An apparatus as in claim 1 wherein the foil extends over an exterior side of a joint between the first and second housing sections when the housing sections are in both the open position and the closed position.

4. An apparatus as in claim 1 wherein a connection of the first housing section to the second housing section comprises a pivotable hinge section.

5. An apparatus as in claim 4 wherein the spring is located inside a cavity in the first housing section spaced from the pivotable hinge section.

6. An apparatus as in claim 4 wherein the foil extends over an exterior of the hinge section and at least partially along exterior sides of the first and second housing sections.

7. An apparatus as in claim 6 further comprising a flexible flat printed circuit cable located against an interior side of the foil, wherein the flexible flat printed circuit cable extends over the exterior of the hinge section.

8. An apparatus as in claim 1 wherein the foil is comprised of metal.

9. An apparatus as in claim 1 wherein the foil comprises of a superelastic material.

10. An apparatus as in claim 1 wherein the foil has a width about a same width as the second housing section.

11. An apparatus as in claim 1 wherein the foil has a length which is greater than a length of the first housing section and greater than a length of the second housing section.

12. An apparatus as in claim 1 wherein the spring comprises a coil spring.

13. An apparatus as in claim 1 wherein the spring comprises at least two spaced springs connected to an end of the foil.

14. An apparatus as in claim 1 wherein an exterior of the foil comprises plated or engraved decoration.

15. An apparatus as in claim 14 wherein the foil is removably connected to the first and second housing sections such that an end user can replace the foil with a second different foil having a different plated or engraved decoration on the exterior of the second foil.

16. An apparatus as in claim 1 wherein the spring comprises an extension and contraction axis parallel to an elongate longitudinal axis of the first housing section.

17. An apparatus as in claim 1 wherein the apparatus is a mobile, hand-held communications device comprising a transceiver and a display screen.

18. An apparatus comprising:
a first housing section;
a second housing section pivotably connected to the first housing section at a hinge section, wherein the second housing section is pivotable relative to the first housing section between a closed position and an open position;
a flexible thin sheet member extending between the first and second housing sections over an exterior of the hinge section, wherein the sheet member is located at least partially along outside surfaces of the first and second housing sections, and wherein a first end of the sheet member is stationarily attached to the second housing section; and
a connection of the sheet member to the first housing section, wherein the connection comprises a spring connected between the first housing section and an opposite second end of the sheet member, wherein the spring exerts a pulling force on the second end of the sheet member in a predetermined direction on the first housing section.

19. An apparatus as in claim 18 wherein the spring is located inside a cavity in the first housing section spaced from the hinge section.

20. An apparatus as in claim 18 wherein the sheet member extends over an exterior of the hinge section.

21. An apparatus as in claim 20 further comprising a flexible flat printed circuit cable located against an interior side of the sheet member, wherein the flexible flat printed circuit cable extends over the exterior of the hinge section.

22. An apparatus as in claim 18 wherein the sheet member is comprised of metal.

23. An apparatus as in claim 18 wherein the sheet member comprises a superelastic material.

24. An apparatus as in claim 18 wherein the sheet member has a width about a same width as the second housing section and the hinge section.

25. An apparatus as in claim 18 wherein the sheet member has a length which is greater than a longitudinal length of the first housing section and greater than a longitudinal length of the second housing section.

26. An apparatus as in claim 18 wherein the spring comprises a coil spring.

27. An apparatus as in claim 18 wherein the spring comprises at least two spaced springs connected to the second end of the sheet member.

28. An apparatus as in claim 18 wherein an exterior of the sheet member comprises plated or engraved decoration.

29. An apparatus as in claim 28 wherein the sheet member is removably connected to the first and second housing sections such that an end can replace the sheet member with a second different sheet member having a different plated or engraved decoration on the exterior of the second sheet member.

30. An apparatus as in claim 18 wherein the spring comprises an extension and contraction axis parallel to an elongate longitudinal axis of the first housing section.

31. A method comprising:
rotatably connecting a first housing section with a second housing section at a hinge section;
connecting a flexible thin foil member to the second housing section, wherein the thin foil member extends over an exterior of the hinge section and onto the first housing section; and
connecting a spring between the foil member and the first housing section to bias the foil member in tension towards a predetermined direction on the first housing section.

32. A method as in claim 31 wherein connecting the spring between the foil member and the first housing section comprises inserting an end of the foil member from an exterior side of the first housing section through a slot in the first housing section.

33. A method comprising:
rotating first and second housing sections relative to each other from a closed position towards an open position; and
pulling on a foil member by a spring as the first and second housing sections are moved towards the open position, wherein the foil member is located over an exterior side of a hinge section connecting the first and second housing sections to each other, and wherein the spring connects the foil member to the first housing section to pull the foil member in a predetermined direction on the first housing section as the first and second housing sections move towards the open position.

34. A method as in claim 33 further comprising pulling a portion of the foil member inside the first housing section as the first and second housing sections move towards the open position.
